(19) United States
(12) Patent Application Publication
(10) Pub. No.: US 2002/0026331 A1
(43) Pub. Date: Feb. 28, 2002

(54) System and method for providing a server-based wireless communication of medical test requests and results

(76) Inventor: Robert Case, Chicago, IL (US)

Correspondence Address: MERCHANT & GOULD PC, P.O. BOX 2903, MINNEAPOLIS, MN, 55402-0903, US

(21) Appl. No.: 09/822,092

(22) Filed: Mar. 30, 2001

Related U.S. Application Data
(60) Provisional application No. 60/193,883, filed on Mar. 31, 2000.

(51) Int. Cl. G06F 17/60

(52) U.S. Cl. 705/3

(57) ABSTRACT

A server-based lab test message processor is in digital communications with a remote data input terminal for a receiving medical patient requests and transmitting test results. The server-based lab test message processor includes a control processing module for controlling the operation of the server. The server also includes a test request message receive module for receiving medical test request messages from the remote data input terminal, the medical test request messages contain test identification information for identifying the medical patient test and patient identification information for identifying the patient, a test result message transmit module for sending medical test result messages to the remote data input terminal, the test result messages contain test identification information for identifying the medical patient test performed and patient identification information for identifying the patient, and a test result message receive module for receiving medical test result messages from a lab testing facility. The control processing module matches test request with test result messages and the test request messages using the test identification information and the patient identification information to send the test results to appropriate individuals.

This application claims priority from provisional application serial No. 60/193,883, filed Mar. 31, 2000, and which is incorporated herein by reference.

### TECHNICAL FIELD

This application relates in general to a method, apparatus, and article of manufacture for providing remote communication of medical test requests and corresponding test results, and more particularly to a method, apparatus, and article of manufacture for providing wireless communication of test orders from a health care provider to a medical testing system that automatically transmits the test results, when completed to one or more designated health care providers.

### BACKGROUND

Health care providers in many situations need to request various medical laboratory tests be performed in a time-critical fashion as part of any diagnosis process that precedes treatment for a patient's condition. The process of obtaining these laboratory test results typically requires a qualified health care provider, such as a physician, to generate a set of requests, or orders, for the desired laboratory tests to be performed. These orders are recorded and passed to a care-giver who obtains any necessary test samples, such as a vial of blood, who in turn sends the samples, with written laboratory test requests, to a testing laboratory to perform the requested test upon the sample. The laboratory is typically not part of the patient care department where the patient and care-giver are located. Once the request and sample are received in the laboratory, the medical test may be performed. The laboratory typically generates a report containing the resultant test results after some period of time. The test result report is then forwarded back to the patient care department for inclusion within a patient chart. Once the results are received, the care-giver will then attempt to locate the physician with the laboratory test results in order to continue the diagnosis process.

The above process involves numerous opportunities for the test requests and test results to be delayed and thus not allowing the physician to continue a patient diagnosis process, a process which may require multiple rounds of testing before a diagnosis that permits meaningful treatment to begin. For example, the request from the physician to a care-giver may be misplaced. A written test request may not be matched with a test sample and timely forwarded to the laboratory. The test results may be delayed it their return to the patient care department. Finally, the physician may not be present in the patient care department while attending to other duties when the results are received in the patient care department. As a result, the diagnosis process may be delayed while a replacement physician is located, the requesting physician is located, or the requesting physician returns to the patient care department. These delays may be caused by no fault of the responsible individuals who are responsible for a large number of simultaneous tasks that may all demand the immediate attention of the responsible individual.

### SUMMARY

In accordance with the present invention, the above and other problems are solved by providing a method, apparatus, and article of manufacture for providing wireless communication of test orders from a health care provider to a medical testing system that automatically transmits the test results, when completed to one or more designated health care providers.

One aspect of the present invention is a method for requesting and receiving medical patient test results using a remote data input terminal in communication with a server-based lab test message computer. The method includes receiving a test sample collected to perform the requested medical patient test with the patient identification information and the test identification information, receiving the patient identification information and the test identification information from the remote data input terminal in order to request the medical patient tests to be performed upon the collected test sample, transmitting a test result message containing test results for the requested medical patient test to the remote data input terminal, and displaying the test results from the requested medical patient test on the remote data input terminal.

Another aspect of the present invention is a server-based lab test message processor is in digital communications with a remote data input terminal for a receiving medical patient requests and transmitting test results. The server-based lab test message processor includes a control processing module for controlling the operation of the server. The server also includes a test request message receive module for receiving medical test request messages from the remote data input terminal, the medical test request messages contain test identification information for identifying the medical patient test and patient identification information for identifying the patient, a test result message transmit module for sending medical test result messages to the remote data input terminal, the test result messages contain test identification information for identifying the medical patient test performed and patient identification information for identifying the patient, and a test result message receive module for receiving medical test result messages from a lab testing facility. The control processing module matches test request with test result messages and the test request messages using the test identification information and the patient identification information to send the test results to appropriate individuals.

These and various other features as well as advantages, which characterize the present invention, will be apparent from a reading of the following detailed description and a review of the associated drawings.

### BRIEF DESCRIPTION OF THE DRAWINGS

Referring now to the drawings in which like reference numbers represent corresponding parts throughout:

FIG. 1 illustrates an automated medical laboratory testing system using a remote communication system according to one embodiment of the present invention.

FIG. 2 illustrates a general purpose computing system for use in implementing one or more computing embodiments of the present invention.

FIG. 3 illustrates a hand-held computing system used by health care providers as part of a laboratory testing system according to another embodiment of the present invention.

FIG. 4 illustrates a hand-held computing system used by health care providers that provides patient test results as part of a laboratory testing system according to another embodiment of the present invention.

FIG. 5 illustrates a laboratory test messaging computing system according to an embodiment of the present invention.

FIG. 6 illustrates a test request data record transmitted to the laboratory test messaging computing system according to another embodiment of the present invention.

FIG. 7 illustrates a test results data record transmitted to the laboratory test messaging computing system according to an embodiment of the present invention.

FIG. 8 illustrates a main menu user interface screen for a hand-held computing system used by health care providers according to another example embodiment of the present invention.

FIGS. 9 illustrates a sign-in user interface screen for a hand-held computing system used by health care providers according to yet another example embodiment of the present invention.

FIG. 10 illustrates a patient processing user interface screen for a hand-held computing system used by health care providers to enter patient ID information according to yet another example embodiment of the present invention.

FIG. 11 illustrates a patient processing user interface screen for a hand-held computing system used by health care providers to generate test sample labels according to yet another example embodiment of the present invention.

FIG. 12 illustrates a patient processing user interface screen for a hand-held computing system used by health care providers to generate additional test sample labels according to yet another example embodiment of the present invention.

FIG. 13 illustrates a patient processing user interface screen for a hand-held computing system used by health care providers to identify recipients of test results according to yet another example embodiment of the present invention.

FIGS. 14a and 14b illustrate a test results user interface screen for a hand-held computing system used by health care providers to receive patient test results according to yet another example embodiment of the present invention.

FIG. 15 illustrates a hand-held health care provider computing system according to an embodiment of the present invention.

FIG. 16 illustrates operational flow for a laboratory test messaging computing system according to an embodiment of the present invention.

FIG. 17 illustrates operational flow for a hand-held health care provider computing system according to an embodiment of the present invention.

### DETAILED DESCRIPTION

This application relates in general to a method, apparatus, and article of manufacture for providing remote communication of medical test requests and corresponding test results.

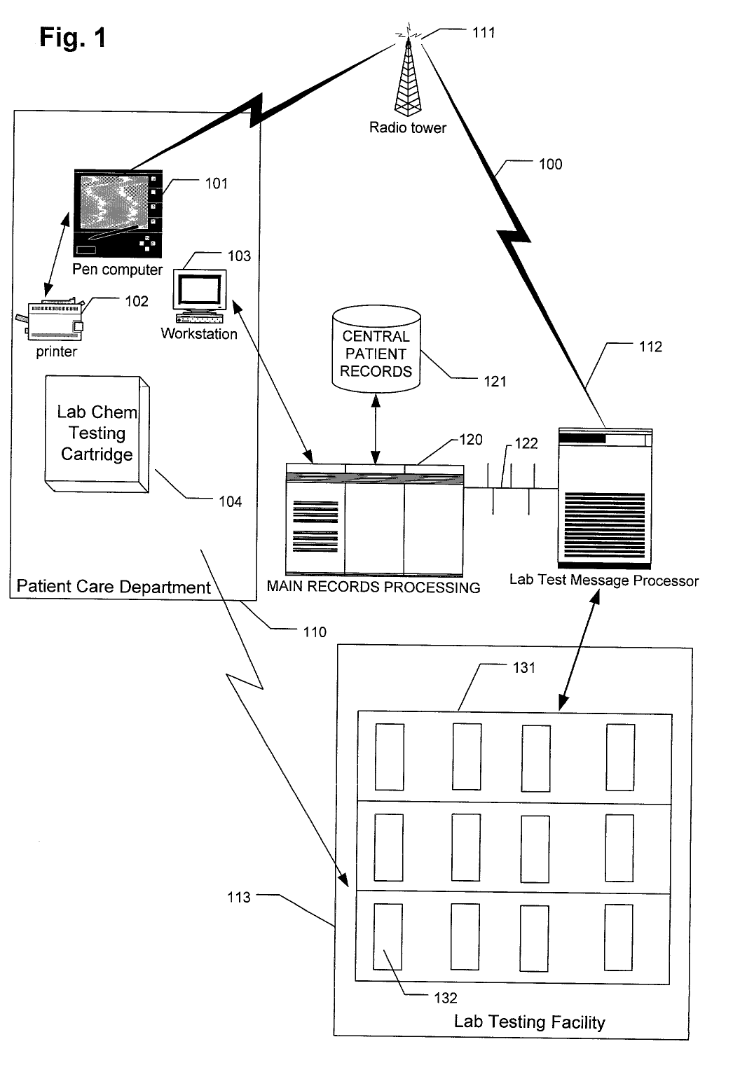

FIG. 1 illustrates an automated medical laboratory testing system using a remote communication system according to one embodiment of the present invention. The system is centered upon the use of a hand-held computer 101 by health care professionals to enter data related to a test to be performed for a patient. The hand-held computer 101 also receives test results for review and use by these health care professionals in the diagnosis and treatment of the patients.

The hand-held computer 101 communicates with a laboratory testing facility 113 to request that tests be performed and to receive the test results once generated by the laboratory testing facility 113. In an exemplary embodiment, this communication is implemented as a wireless communications network that utilizes RF signals to provide a digital communications network to the hand-held computer 101 wherever the computer 101 is located within a patient care department 110. Using such a network, a health care provider may order a test be performed while visiting a patient or while reviewing a patient's chart and have the order be entered into the testing system for processing. In addition, a set of one or more test results may be transmitted to hand-held computer 101 for review by the health care provider as soon as they are available using the network. The communications network 100 also permits these same test results be transmitted to a plurality of health care providers who possess these hand-held computers 101 to allow for consultation and cooperation between various health care providers as well as allow for multiple health care providers to respond to a patient's needs following the generation of test results which improves the likelihood that at least one health care provider will be free to provide further treatment to a patient as soon as the test results are made generated.

The hand-held computer 101 communicates over the communications network 100 by transmitting RF signals to a antenna that communicates with a lab test message processor 112. The lab test message processor 112 is a server-based computing system that is typically part of the laboratory testing facility 113 where testing samples from patients are brought for processing to generate test results. In many hospitals and similar health care facilities, these laboratories are situated away from patient care departments such as emergency rooms, intensive care units, patients wards, and surgical suites. The lab test message processor 112 receives an electronic test order message from a hand-held computer 101 that requests a test be performed for a patient. This message is maintained within the lat test message processor 112 until test results are generated in the lab testing facility 131. When these results are generated, the lab test message processor 112 transmits these results to one or more designated health care providers and the test request message is marked as being completed.

The lab test message computer 112 also communicates with testing equipment 131 that generates the test results. Typically, this testing equipment 131 includes computer controlled laboratory equipment that accepts patient test samples in some form and automatically performs a test to generate the desired test results. In an exemplary embodiment, this testing equipment operates upon patient body samples and fluids such a vials of human blood to measure various characteristics such as red blood cell and white blood cell count, pH, and various levels of substances found within the sample. One skilled in the art will recognize that any automated testing equipment that is capable of electronically communicating with a computing system 112 to report test results may be used without deviating from the spirit and scope of the invention as recited within the attached claims.

The lab test message computer 112 may also communicate with other computing systems, such as a main records processing system 120 over a communications network 122 to automatically place a copy of the test results generated within a computer data store 121 that maintains central client records for the health care facility. For patient records systems that permit remote access of these patient records using remote workstations 103, the test results generated may be accessed by health care providers who do not possess a hand-held computer 101.

The above testing system operates by having the lab test message processor 112 match the test request messages with the corresponding test results once the test results have been generated. This data matching operation occurs by having the test samples correctly labeled with an ID that identifies the patient and the test to be performed. This identifying information is generated by a hand-held computer 101 when the initial test request is created. This information is placed upon the test sample when collected from a patient by labeling the container holding the sample. In an exemplary embodiment, this container is a sample test cartridge 104 that contains the necessary chemistry to perform the requested test. Additional information regarding one possible embodiment for the sample test cartridge 104 is described in commonly assigned U.S. patent application titled, Fluid Cartridge and Method, U.S. Ser. No. 09/662,711, filed Sep. 20, 2000, which is incorporated by reference. The cartridge receives a label containing computer readable identifying markings, such as a bar code, that contains the identifying information. The label can be generated by a printer 102 that is capable of generating the bar code markings from communication received from the hand-held computer. These labels may either be generated by instructions given by the hand-held computer 101 or be pre-printed labels that contain the necessary patient identification information.

The lab testing facility 113 then receives the sample in the cartridge 104 from the patient care department. The lab testing facility may perform the requested test to the test sample and attach the identifying information read from the bar code markings to the test results generated when it is transmitted to the lab test messaging processor 112. The identifying information would typically include data such as the identity of the patient, the identify of the test, the date and time the test was requested, the identify of the requesting party, and other useful information as necessary.

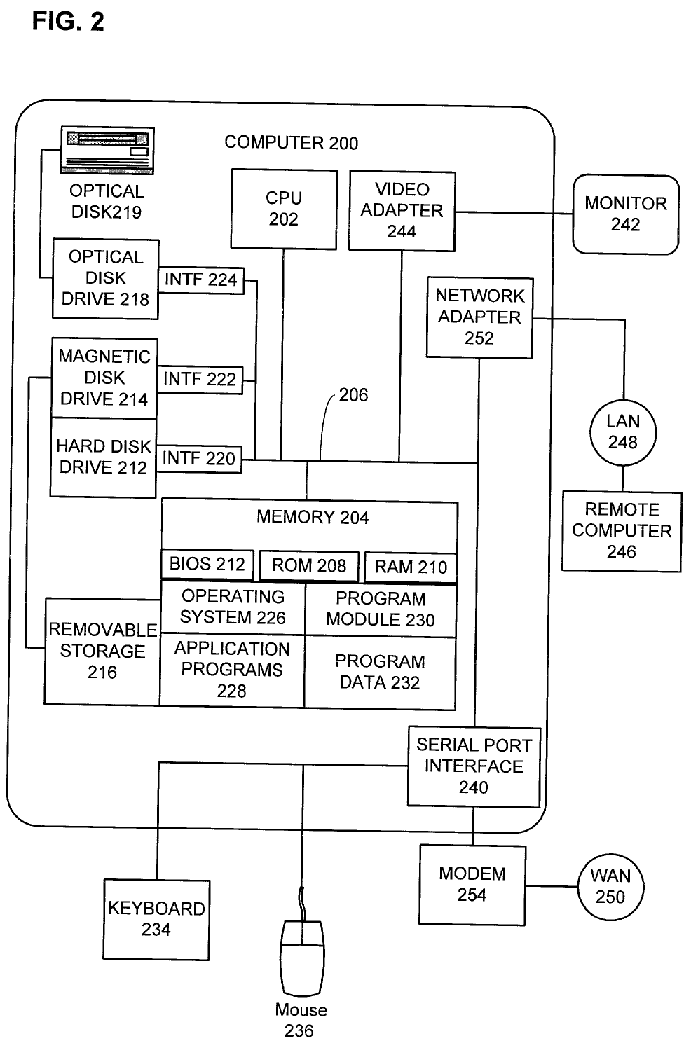

With reference to FIG. 2, an exemplary system for implementing the invention includes a general-purpose computing device in the form of a conventional personal computer 200, including a processor unit 202, a system memory 204, and a system bus 206 that couples various system components including the system memory 204 to the processor unit 200. The system bus 206 may be any of several types of bus structures including a memory bus or memory controller, a peripheral bus and a local bus using any of a variety of bus architectures. The system memory includes read only memory (ROM) 208 and random access memory (RAM) 210. A basic input/output system 212 (BIOS), which contains basic routines that help transfer information between elements within the personal computer 200, is stored in ROM 208.

The personal computer 200 may also further include a hard disk drive 212 for reading from and writing to a hard disk, a magnetic disk drive 214 for reading from or writing to a removable magnetic disk 216, and an optical disk drive 218 for reading from or writing to a removable optical disk 219 such as a CD ROM, DVD, or other optical media. The hard disk drive 212, magnetic disk drive 214, and optical disk drive 218 are connected to the system bus 206 by a hard disk drive interface 220, a magnetic disk drive interface 222, and an optical drive interface 224, respectively. The drives and their associated computer-readable media provide nonvolatile storage of computer readable instructions, data structures, programs, and other data for the personal computer 200.

Although the exemplary environment described herein employs a hard disk, a removable magnetic disk 216, and a removable optical disk 219, other types of computer-readable media capable of storing data can be used in the exemplary system. Examples of these other types of computer-readable mediums that can be used in the exemplary operating environment include magnetic cassettes, flash memory cards, digital video disks, Bernoulli cartridges, random access memories (RAMs), and read only memories (ROMs).

A number of program modules may be stored on the hard disk, magnetic disk 216, optical disk 219, ROM 208 or RAM 210, including an operating system 226, one or more application programs 228, other program modules 230, and program data 232. A user may enter commands and information into the personal computer 200 through input devices such as a keyboard 234 and mouse 236 or other pointing device. Examples of other input devices may include a microphone, joystick, game pad, satellite dish, and scanner. These and other input devices are often connected to the processing unit 202 through a serial port interface 240 that is coupled to the system bus 206. Nevertheless, these input devices also may be connected by other interfaces, such as a parallel port, game port, or a universal serial bus (USB). A monitor 242 or other type of display device is also connected to the system bus 206 via an interface, such as a video adapter 244. In addition to the monitor 242, personal computers typically include other peripheral output devices (not shown), such as speakers and printers.

The personal computer 200 may operate in a networked environment using logical connections to one or more remote computers, such as a remote computer 246. The remote computer 246 may be another personal computer, a server, a router, a network PC, a peer device, a pen based computer, a personal digital assistant or other common network node, and typically includes many or all of the elements described above relative to the personal computer 200. The network connections include a local area network (LAN) 248 and a wide area network (WAN) 250. Such networking environments are commonplace in offices, enterprise-wide computer networks, intranets, and the Internet.

When used in a LAN networking environment, the personal computer 200 is connected to the local network 248 through a network interface or adapter 252. When used in a WAN networking environment, the personal computer 200 typically includes a modem 254 or other mechanism for establishing communications over the wide area network 250, such as the Internet. The modem 254, which may be internal or external, is connected to the system bus 206 via the serial port interface 240. In a networked environment, program modules depicted relative to the personal computer 200, or portions thereof, may be stored in a remote memory storage device. It will be appreciated that the network connections shown are exemplary, and other means of establishing a communications link between the computers may be used.

Additionally, the embodiments described herein are implemented as logical operations performed by a computer. The logical operations of these various embodiments of the present invention are implemented (1) as a sequence of computer implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

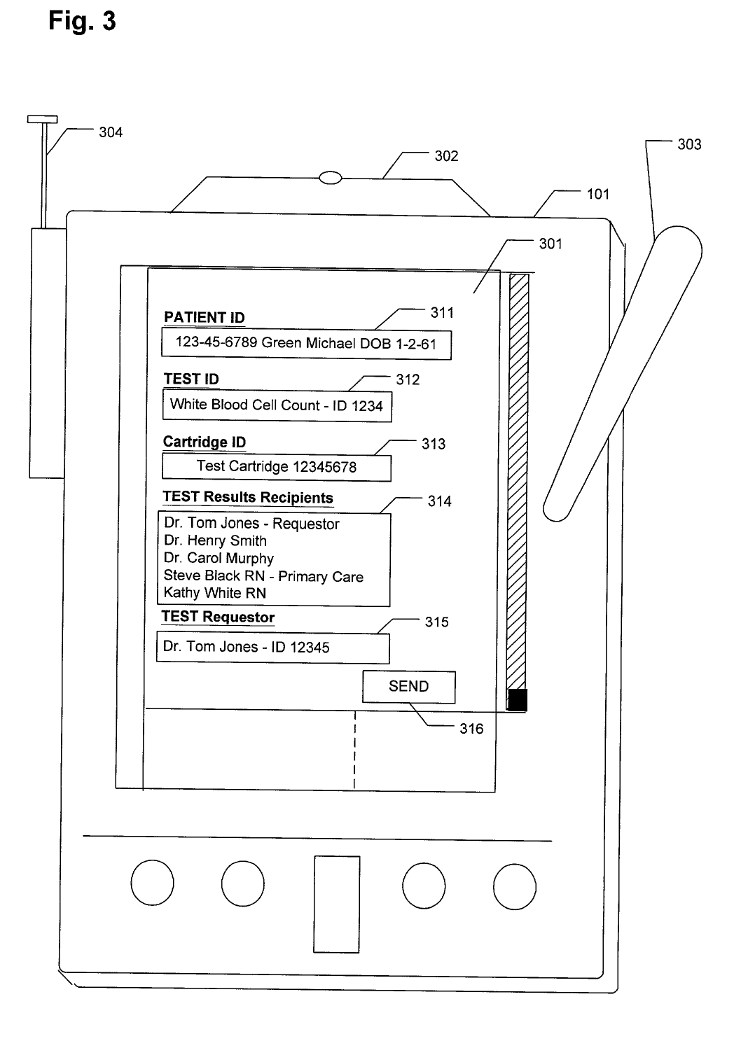

FIG. 3 illustrates a hand-held computing system used by health care providers as part of a laboratory testing system according to another embodiment of the present invention. In an exemplary embodiment, the hand-held computer 101 is a pen-based computing system such as a PDA computer from PALM COMPUTING or a POCKET PC computer running a version of WINDOWS CE. The hand-held computer 101 includes a user interface screen 301 that displays test information 311-315 and accepts input commands 316 from a health care provider. As a pen-based computer 101, the user may enter data into the device 101 using a stylus 303 that writes pen-strokes and generates screen clicks on the user interface screen 301.

The hand-held computer 101 also has an RF signal antenna 304 connected to supporting transmitter and receiver modules for providing the wireless communications to the communications network 100. This communications network 100 is typically a packetized digital communications network such a networks that provide cellular, PCS, and similar communications. Because these communications networks are located within a patient care department 110, wireless local area networks that use well defined communications protocols such as the IEEE 802.11b or a BLUETOOTH protocol may be used for this wireless communications network.

The hand-held computer 101 also may include a scanning device 302 that is capable of reading bar code markings that provide the hand-held computer 101 with the identifying information associated with the patient, with the test sample and cartridge, and the health care provider ordering the test and generating the test sample. By using a bar code scanner 302 to obtain this information rather than having a user manually enter the information, error associated with the generation of the needed data will be reduced. Of course, a user may enter the information manually if needed using the stylus 303 and the user interface screen 301.

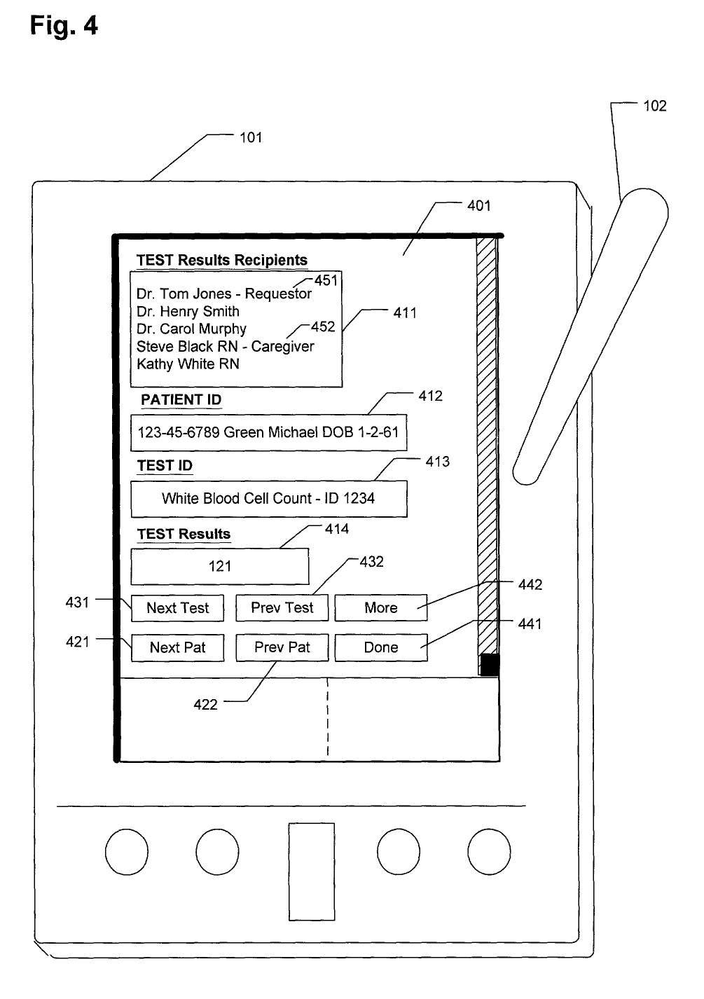

FIG. 4 illustrates a hand-held computing system used by health care providers that provides patient test results as part of a laboratory testing system according to another embodiment of the present invention. The hand-held computer 101 also presents test results 411-414 generated in response to a test request to a health care provider. Because the hand-held computer 101 is a general purpose, programmable computer, any data that may be displayed upon a user interface screen 401 may be included in the data. For example, the test results may display the identity of all recipients of the test results in a field 411. The individual recipients may be further identified as an individual who requested the test be performed 451, such as a physician, and an individual who is a primary care-giver 452, such as a nurse who collected the test sample and forwarded it to the lab facility. Any such information that is captured within the system may be transmitted to a hand-held computer 101 and displayed as part of the test results.

The hand-held computer 101 may also accept various user input commands to assist in the review of additional test results for a given patient 431-432, assist in the review of test results for a different patients 421-422, or complete an operation 441.

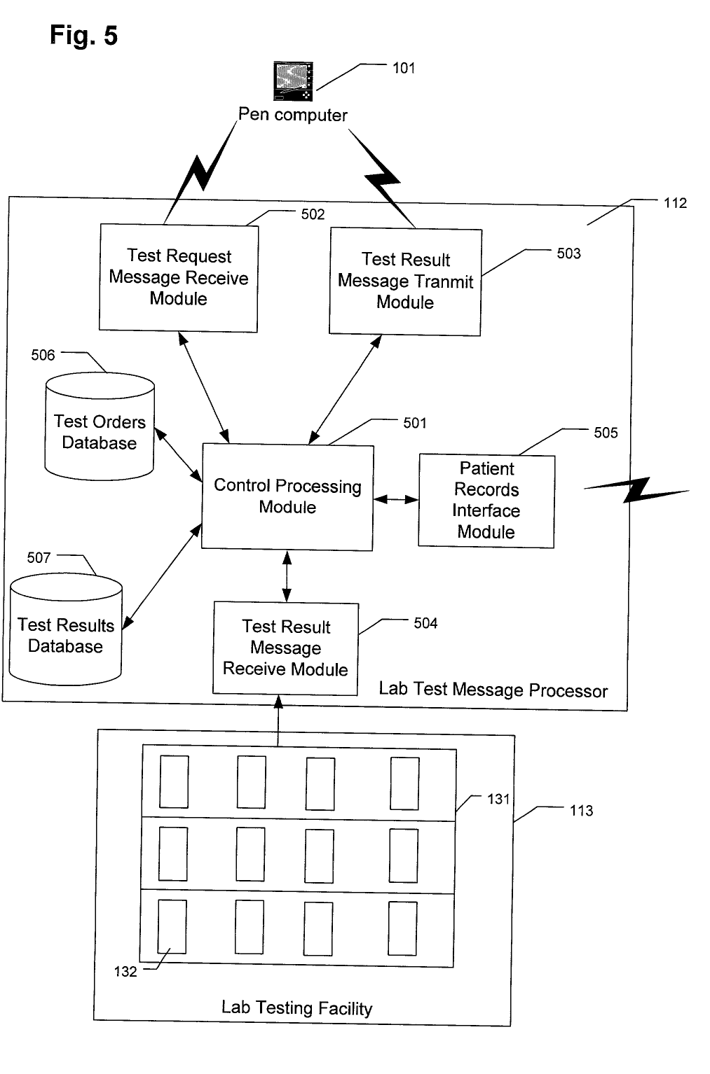

FIG. 5 illustrates a laboratory test messaging computing system according to an embodiment of the present invention. As was discussed above with regards to FIG. 1, a test message requesting a test is transmitted from a hand-held computer 101 to a test request message receive module 502 within the lab test message processor 112. This module 502 processes the incoming communications packet to receive a test request message and passes the incoming message to a control processing module 501. The control processing module 501 may verify that the test is not a duplicate test request by searching a test order database 506. If the test request is not a duplicate, the control processing module 501 places the test request message within the test order database 506 for use when the test results are generated.

This test request message remains in the test order database 506 until the test sample is obtained from a patient and the test cartridge is brought to the lab testing facility 113 in order for the requested test to be performed. The testing equipment 132 generates the test results and transmits them to a test result message receive module 504 along with the identifying information read from the bar code markings on the test sample cartridge 104. The test result message receive module 504 transmits the test result message to the control processing module 501 for eventual transmission to the appropriate parties.

The control processing module 501 stores the test result message within a test results database 507 for temporary keeping until the processing associated with the test results has been completed. Once the test result messages have been saved, the control processing module 501 may attempt to match the test result message with the test request message using the identifying information associated with the two data records. When a match is found, the test result message may be transmitted to one or more hand-held computers 101 as specified within the test request message using a test result message transmit module 503. This test result message transmit module 503 provides the necessary processing to format the test results to match the communications protocol of the communications network 100.

The control processing module 501 may also pass the matched test request message and the corresponding test result message to a client records interface module 505. This interface module 505 processes this data into a format that is acceptable for passage to a health care facility central records department. These test records are eventually included within a patient's chart for permanent storage of the results.

The control processing module 501 will eventually remove the test request message and corresponding test result message from the two message databases 506-507 once all of the above processing is completed. Of course, these messages may be retained for a predetermined period of time following the completion of the processing to permit the further processing of the data should an error in transmission occur in any of the above processing.

In addition, one skilled in the art will recognize that the above processing has been described as a set if different operations that occur separate from each other. This processing may be combined into a different combination of the above operations as a matter of design choice in order to satisfy performance requirements of the overall system. For example, the control processing module 501 may place an emphasis on processing incoming messages and storing them into the two databases 506-507 over the processing associated with matching test requests with test results as the control processing module 501 does not want to miss an incoming message. If the incoming message rate is not great, this performance related design trade-off may not be necessary.

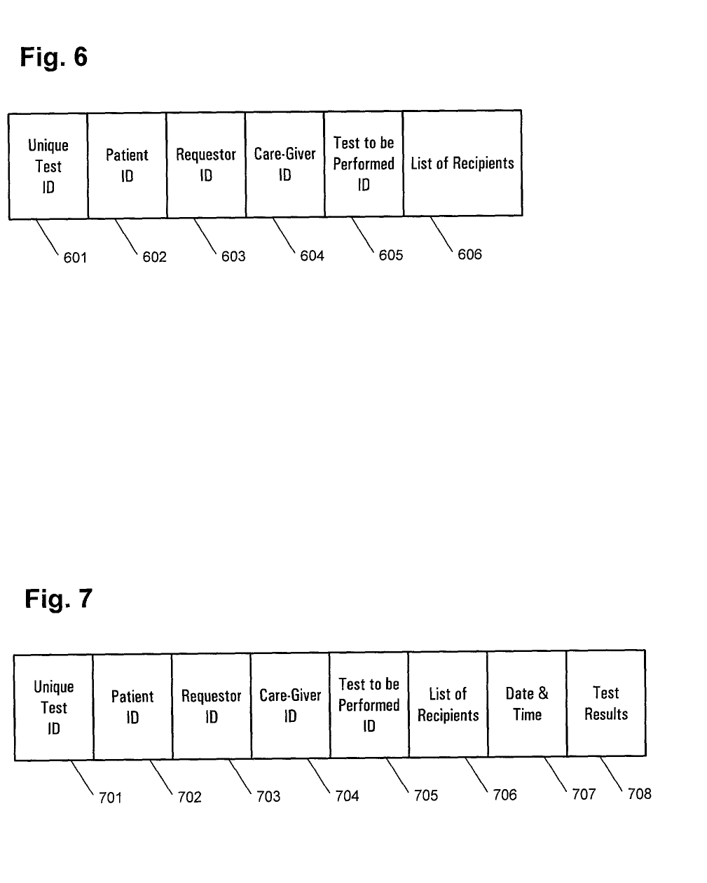

FIG. 6 illustrates a test request data record 600 transmitted to the laboratory test messaging computing system according to another embodiment of the present invention. The test request record 600 may be the record transmitted from the hand-held computer 101 to the lab test message processor 110 and the data record stored within a data store used to maintain the test request database 506. This data record includes data fields containing a unique test ID 601, a patient ID 602, a test requestor ID 603, a caregiver ID 604, a test to be performed ID 605, and a list of one or more recipients of the test results 606.

The test ID 601 provides a mechanism to uniquely identify the test request from all other test requests processed in the system. The test ID 601 is a unique ID number for the test that is unlikely to be repeated for a significantly long period of time to avoid possible errors associated with mismatched test requests and test results.

The patient ID 602 is a unique identifier for each patient treated within a health care facility. In an exemplary embodiment, a bar code identifier containing this ID is worn by the patient. A care-giver, such as a nurse, will scan the bar code identifier when the test sample is generated. As such, the system is likely to correctly identify the test sample as belonging to the patient in question. A test requestor, such as a physician, will enter this ID into the system by scanning a patient's chart when the test is ordered. When these IDs match along with a match for all other information in these records, the test is being performed correctly.

The requestor ID 603 is obtained from the hand-held computer 101 for the individual logged into this computer 101 when the test request message is generated. In addition, the hand-held computer 101 may use this identifier to determine if the user is entitled to generate the test request.

The care-giver ID 604 is obtained from the hand-held computer 101 that generates a label that is to accompany the test sample from the patient care department 110 to the lab testing facility 113. As is discussed above, the hand-held computer 101 may print out a label containing computer readable identifying information in the form of a bar code when the test sample is obtained. By including the ID for the user who generates the label as a mechanism of identifying the person who obtained the test sample, questions and errors associated with a given test and corresponding test results may be resolved. By including this information within all of the data records, the likelihood of errors is reduced.

The test to be performed ID 605 provides that lab testing facility 113 with a mechanism to verify the test being performed matches the test requested. The ID 605 identifies the type of test that is to be performed. If a lab chemical testing cartridge 104 is used, the lab testing facility may verify that the test sample has been placed within the correct type of cartridge to perform the requested test. As such, errors associated with performing the wrong test upon a sample may be caught and corrected more quickly.

Finally, a list of recipients field 606 provides a list of the identities for the parties who are to receive the test results once they have been generated. These recipients may be identified using a unique address where the data associated with the test results may be sent. In the example embodiment, this address may be associated with the ID of the hand-held computer 101 assigned to an individual. The address may also correspond to the ID for the hand-held computer 101 that the recipient of the test results has logged into when the message is to be sent. While the embodiment described herein uses the hand-held computers 101 to generate test requests and to receive test results, one skilled in the art will recognize that any computer capable of communicating with the lab test message processor 112 may be used without deviating from the spirit and scope of the present invention as recited within the attached claims.

FIG. 7 illustrates a test results data record 700 transmitted from the laboratory test messaging computing system according to an embodiment of the present invention. The test result record 700 may be the record transmitted to the hand-held computer 101 to the lab test message processor 110 and the data record stored within a data store used to maintain the test result database 507. This data record includes data fields containing a unique test ID 701, a patient ID 702, a test requester ID 703, a caregiver ID 704, a test to be performed ID 705, and a list of one or more recipients of the test results 706.

The unique test ID 701 provides the same mechanism to uniquely identify the test request from all other test requests processed in the system as discussed with respect to the test request data record 600 in FIG. 6. The ID 701 once again is a unique ID number for the test that is expected to match the unique test ID in the test request data record 600.

The patient ID 702 is a unique identifier for each patient treated within a health care facility as discussed above. The requestor ID 703 is used to identify the user responsible for requesting that a particular test be performed. The care-giver ID 704 is used to identify the user who generates the label as a mechanism of identifying the person who obtained the test sample from a patient.

The test to be performed ID 705 provides that lab testing facility 113 with a mechanism to verify the test being performed matches the test requested. The list of recipients field 706 provides a list of the identities for the parties who are to receive the test results once they have been generated. The Date & Time field 707 provides a time stamp for when the test results were created as a means to distinguish between multiple sets of tests performed for a patient. The test result field 708 provides the actual results from the test performed upon the patient test sample.

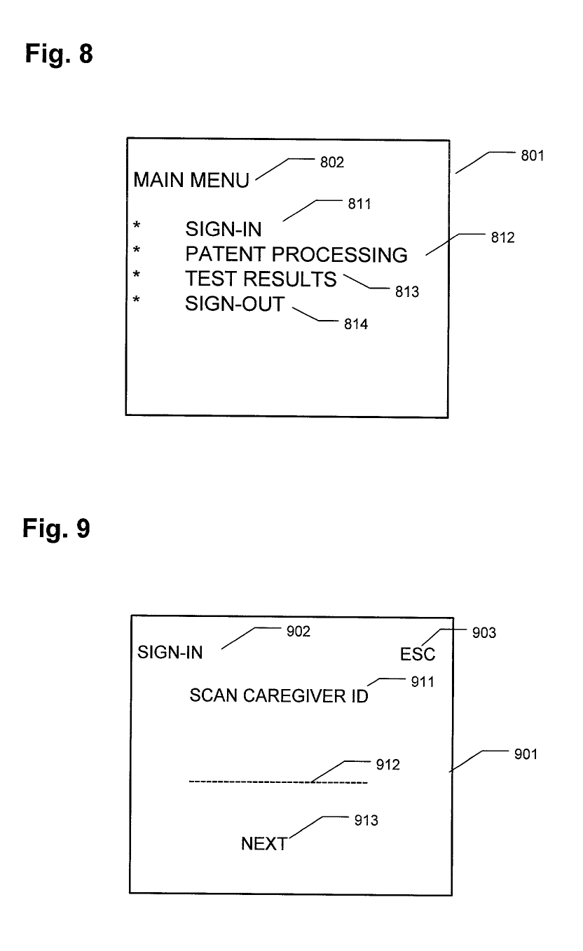

FIGS. 8-14 illustrate a set of user interface screens for another example embodiment of the hand-held computer 101 used to implement the testing system. FIG. 8 illustrates a main menu user interface screen for a hand-held computing system used by health care providers according to another example embodiment of the present invention. The screen 801 provides a user with a set of command choices 811-814 and a screen title 802 that is typically presented when a user is to begin a session that either generates a test request or receives a set of test results for review. The main menu includes various commands such as sign-in 811, patient processing 812, test results 813, and sign-out 814.

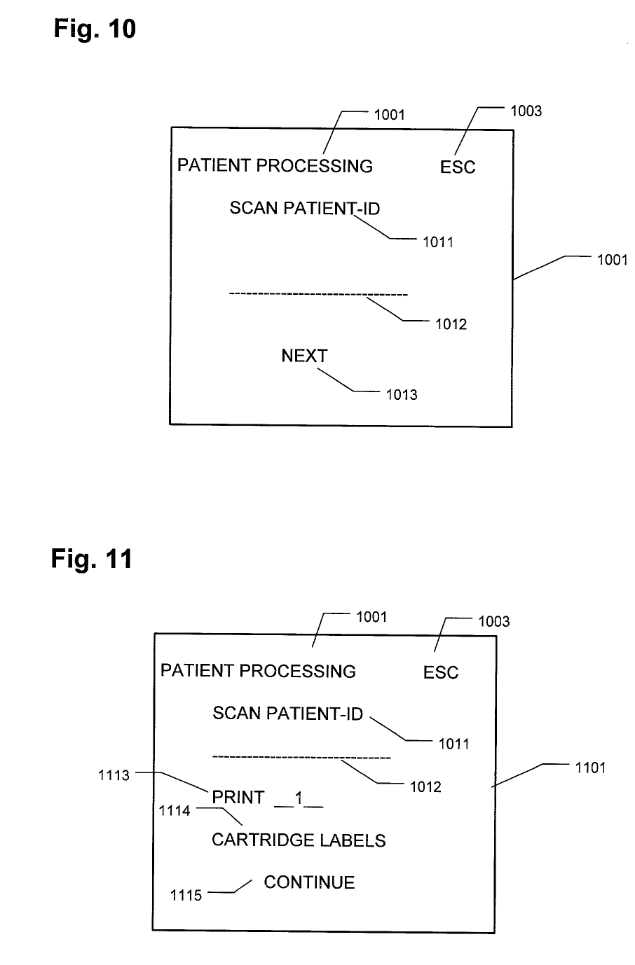

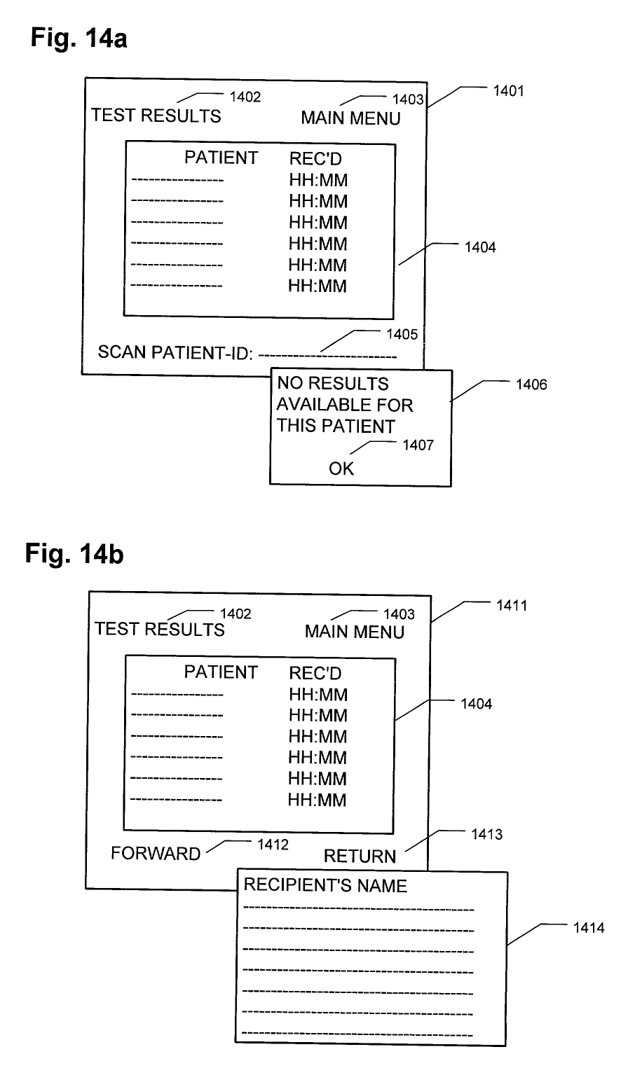

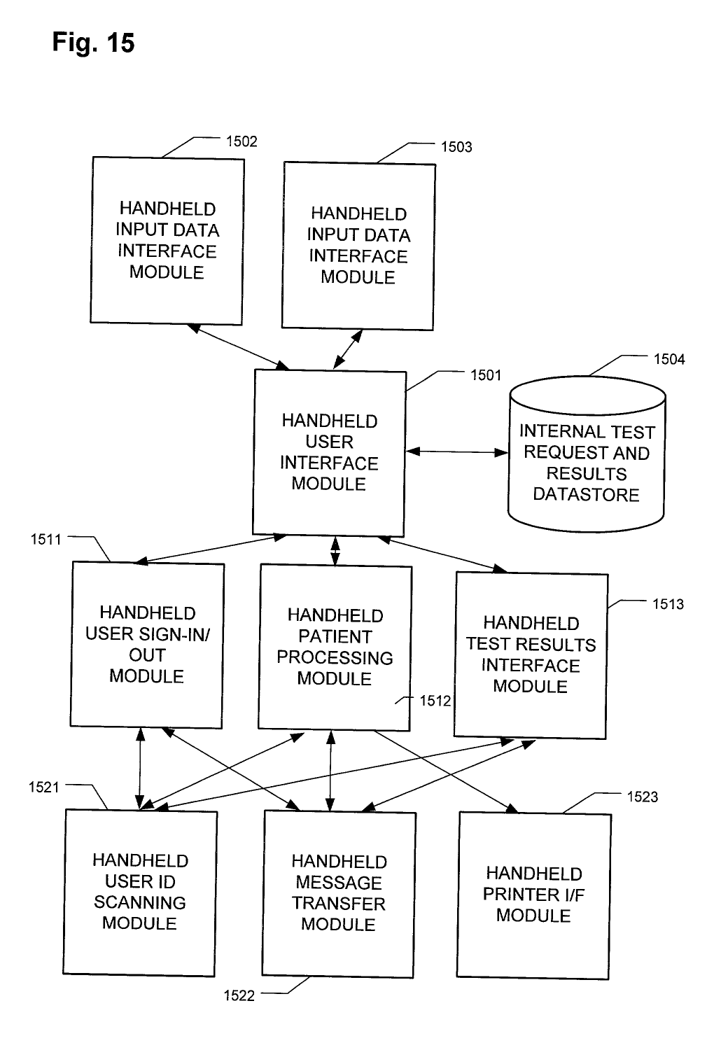

A user interacts with these menus using the hand-held computer 101 and its user interface screen 301. For example, each menu item may correspond to a command button that causes the hand-held computer to perform as associate operation when a pen click is generated by depressing the stylus on the screen 301. The sign-in command 811 takes a user to a sign-in screen described in FIG. 9. The patient processing command 812 takes a user to a series of patient processing screens described in FIGS. 10-13. The test results 813 takes a user to a series of test result screens described in FIGS. 14-15. The sign-out command 814 takes a user to a sign-out screen similar to the screen described in FIG. 9 to permit a user to log out of the hand-held computer.

FIGS. 9 illustrates a sign-in user interface screen for a hand-held computing system used by health care providers according to yet another example embodiment of the present invention. The screen provides a user which a mechanism to enter a unique ID in order to identify to the hand-held computer 101 the identity of the user of the computer 101 who generates test requests and receives test results. In an example embodiment, the ID is entered by scanning a bar code associated with the care-giver. This bar code may be located on a user ID typically worn by employees at health care facilities. This bar code may be located at a central location where care-givers obtain hand-held computers 101 for use while in a patient care departmentl 10. A user may also manually enter in the ID using the stylus on the handheld computer 101.

This screen may also include several command buttons such as an ESC command 903 to abort a log-in operation and a NEXT 913 command to inform the hand held computer that the ID has been entered and complete the log-in procedure.

FIG. 10 illustrates a patient processing user interface screen for a hand-held computing system used by health care providers to enter patient ID information according to yet another example embodiment of the present invention. The screen provides a user which a mechanism to enter a unique ID in order to identify to the hand-held computer 101 the identity of a patient who is currently being treated by the user of the computer 101 who generates test requests and receives test results. In an example embodiment, the ID is entered by scanning a bar code associated with the patient. This bar code may be located on a patient wrist-band typically worn by patients in health care facilities. This bar code may be located at a central location where care-givers review patient charts while in a patient care department 110. A user may also manually enter in the ID using the stylus on the hand-held computer 101.

This screen may also include several command buttons such as an ESC command 1003 to abort a current operation and a NEXT 1013 command to inform the hand held computer that the ID has been entered and complete the current procedure.

FIG. 11 illustrates a patient processing user interface screen for a hand-held computing system used by health care providers to generate test sample labels according to yet another example embodiment of the present invention. The screen provides a user with another mechanism to enter a unique ID in order to identify to the hand-held computer 101 the identity of a patient who is currently being treated by the user of the computer 101 who generates test requests and receives test results. In this example embodiment, the ID is entered by scanning a bar code associated with the patient. This bar code may be located on a patient wrist-band typically worn by patients in health care facilities. This bar code may be located at a central location where care-givers review patient charts while in a patient care department 110. A user may also manually enter in the ID using the stylus on the hand-held computer 101.

This screen may also include several command buttons such as an ESC command 1003 to abort a current operation and a NEXT 1013 command to inform the hand held computer that the ID has been entered and complete the current procedure. The screen may also provide commands to specify a number of labels to be printed 1113 for use in identifying test samples to be obtained from a particular patient. Finally, the screen may contain a button 1114 to print labels and continue 1115 to a next step in the testing process.

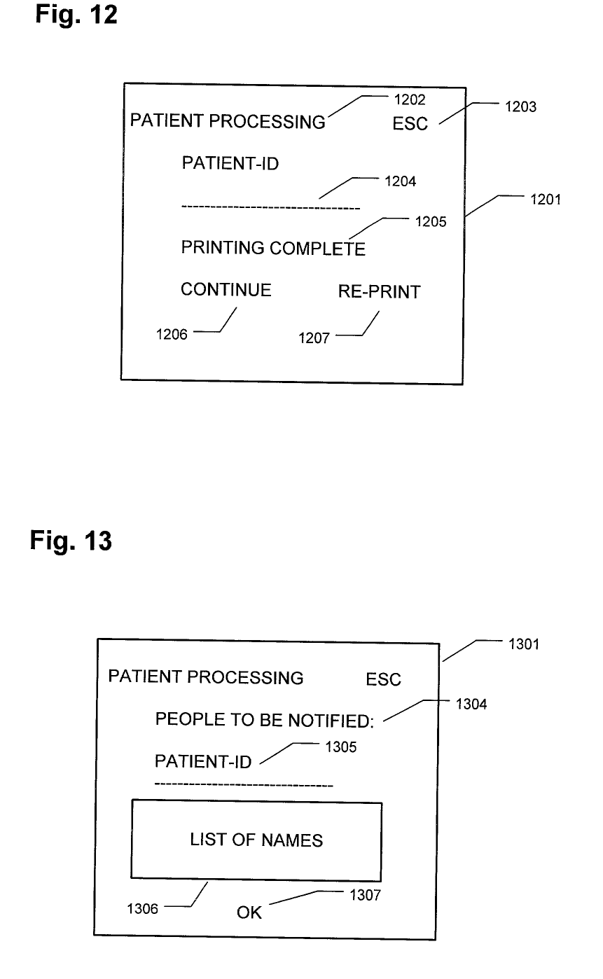

FIG. 12 illustrates a patient processing user interface screen for a hand-held computing system used by health care providers to generate additional test sample labels according to yet another example embodiment of the present invention. The screen provides a user of the hand-held computer 101 an indication that a label has been printed that corresponds to the patient who is currently being treated by the user of the computer 101.

This screen may also include several command buttons such as an ESC command 1203 to abort a current operation and a CONTINUE 1206 command to inform the hand held computer that the operation has been completed. The screen may also provide commands to REPRINT a number of labels 1207 for use in identifying test samples to be obtained from a particular patient.

FIG. 13 illustrates a patient processing user interface screen for a hand-held computing system used by health care providers to identify recipients of test results according to yet another example embodiment of the present invention. The screen 1301 includes a screen title 1304, a patient ID field 1305, and a list of names field 1306. The list of names field 1306 accepts a list of names used as recipients for the test results once generated by the lab testing facility 113. This field may use any number of user interface mechanisms to provide a list of recipients including scanning bar codes, a set of check boxes associated with known individuals, a list of text fields allowing manual entry of names, and any other mechanism to generate a list of recipients. The screen may also include an OK command button 1307 to indicate when all of the desired recipients have been identified to the hand-held computer 101.

FIGS. 14a and 14b illustrate a test results user interface screen for a hand-held computing system used by health care providers to receive patient test results according to yet another example embodiment of the present invention. The test results screen 1401 includes a screen title 1402, a MAIN MENU command button 1403 to return to the main menu screen of FIG. 9, a scrollable results field 1404, a search patient ID command line 1405 to allow a user to locate one or more test results for a particular patient, and a search results pop-up window 1406 for displaying the results of a search. The pop-up window includes an OK command button to indicate that the search results have been read and are no longer needed. The test results field 1404 in this particular embodiment displays the patient ID 1411 and date and time received 1412. If a user generates a screen click upon a result, additional details regarding the test results may be displayed.

FIG. 14b illustrates another embodiment of the test results window that permits a set of test results, most likely to be obtained from a patient ID search, to be forwarded to a set of recipients. When this option is taken, a input window 1414 for generating a list of recipients is presented to generate the list. As was the case in FIG. 13, any number of user interface mechanisms may be utilized to generate this list of recipients without deviating from the spirit and scope of the present invention as recited within the attached claims. The screen 1411 also includes a FORWARD command button 1412 to forward the set of results to the list of recipients 1414, and a RETURN command button 1413 to return to the prior test results screen.

FIG. 15 illustrates a hand-held health care provider computing system according to an embodiment of the present invention. The hand-held computer 101 includes a plurality of processing modules that implement its processing functions. The computer 101 is controlled by a handheld user interface module 1501 that generates the various user interface screens needed to implement the health care testing system 101. The user interface module 1501 interacts with a hand-held input data interface module 1502 to accept input data from the one or more input devices such as the bar code scanner 302 and the user interface screen 301. The user interface module 1501 also interacts with a hand-held output data interface module 1503 to generate output data to the one or more input devices such as the user interface screen 301 and possible audio output devices.

The user interface module 1501 stores its internal data associated with test requests and resulting test result messages within a internal data store 1504. The module places and retrieves the necessary data from this data store during the operation of all other modules.

The user interface module 1501 interacts with a hand-held user sign-in/sign-out module 1511 to process a request to log a user into the handheld computer 101. The sign-in/sign-out module 1511 interacts with a hand-held computer scanning module 1521 to obtain scan input data associated with various ID values used in the processing of test requests and test results. The sign-in/sign-out module 1511 may interact with a hand-held computer message transfer module 1522 to communicate with the lab test message processor to communicate with the message system that a particular user has logged into a particular hand-held computer 101.

The user interface module 1501 interacts with a hand-held patient processing module 1512 to accept input data and corresponding commands associated with generating a test request and obtaining a test sample. The sign-in/sign-out module 1511 interacts with a hand-held computer scanning module 1521 to obtain scan input data associated with various ID values used in the processing of test requests and test results. The hand-held patient processing module 1512 interacts with a hand-held computer message transfer module 1522 to communicate with the lab test message processor in order to inform the message system that a particular test request and test sample have generated by a particular hand-held computer 101. The hand-held patient processing module 1512 also interacts with a hand-held printer interface module 1523 to generate a label for use with a test sample obtained from a patient that is to be sent to the lab testing facility 113.

The user interface module 1501 interacts with a hand-held test results module 1513 to receive and display test results to a user into the handheld computer 101. The hand-held test results module 1513 also accepts input data and commands to forward test results data to one or more recipients input into the hand-held computer 101. The hand-held test results module 1513 interacts with a hand-held computer scanning module 1521 to obtain scan input data associated with various ID values used in the processing of test requests and test results. The hand-held test results module 1513 interacts with a hand-held computer message transfer module 1522 to communicate with the lab test message processor to forward test results to additional recipients.

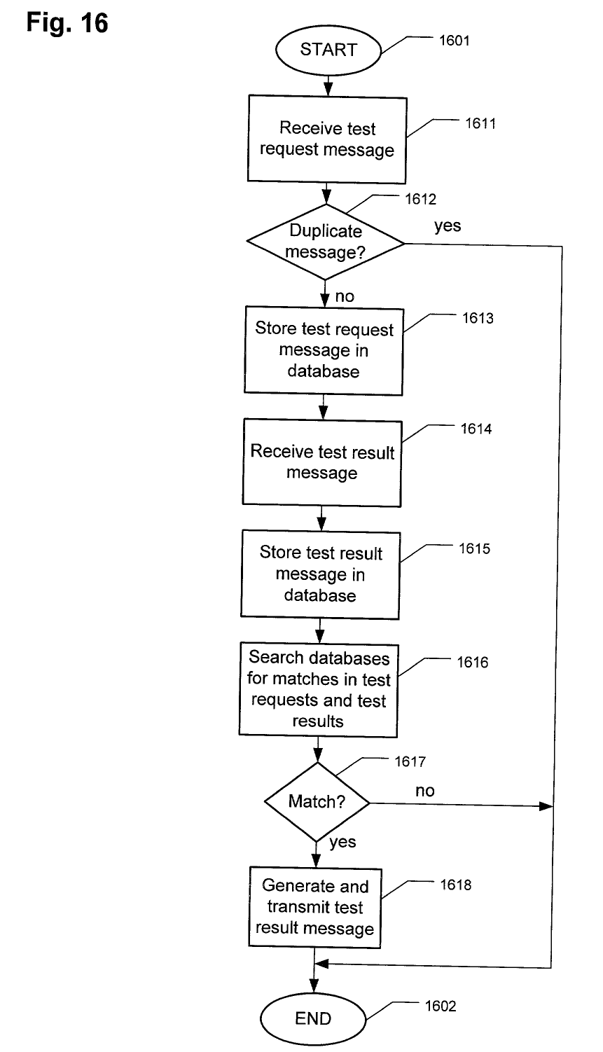

FIG. 16 illustrates operational flow for a laboratory test messaging computing system according to an embodiment of the present invention. The processing on the server-based lab test message processor 112 begins 1601 and the processor waits for the receipt of an incoming test request message in module 1611. When a message is received, the processing in module 1611 extracts the message data from the incoming message packet and formats it for use in the processor 112.

Because of possible network communications errors and because of potential user errors, the processor 112 may check the incoming message against all previously stored messages to determine if the incoming message is a duplicate. If test module 1612 determines that the message is a duplicate test request message, the processing of this message ends 1602. If test module 1612 determines that the message is a not a duplicate test request message, the incoming test request message is stored into a test request message data store in module 1613 for later retrieval and use.

The processing of this test request waits for the arrival of a test results message once the test results have been generated. The processor 112 may receive and process additional test request messages. The processing of the test request resumes when the processor receives a test results message in module 1614. The incoming test results message is stored into a test result message data store in module 1615 for later retrieval and use.

The processor 112 may now search the two data stores, the test request message data store and the test result message data store, for a pair of messages that match as a corresponding pair of request and result messages. Module 1616 compares each message from the two data stores with each other to locate and identify messages having the same unique test ID, same patient ID, and other identifying data. If no matches are found, test module 1617 ends its processing until additional messages are received.

If test module 1617 identifies a matching pair of test request and test result messages, a test result message is generated within module 1618. The module 1618 transmits the test result message to one or more test result recipients identified within the test request message data. The module 1618 may also format the test result message data into a data record for transmission to a central medical records processor for storage within the patient's medical chart. Once these messages have been generated and transmitted, and no additional need for the test request and test result data exists, the data may be removed from the data stores and the processing ends 1602.

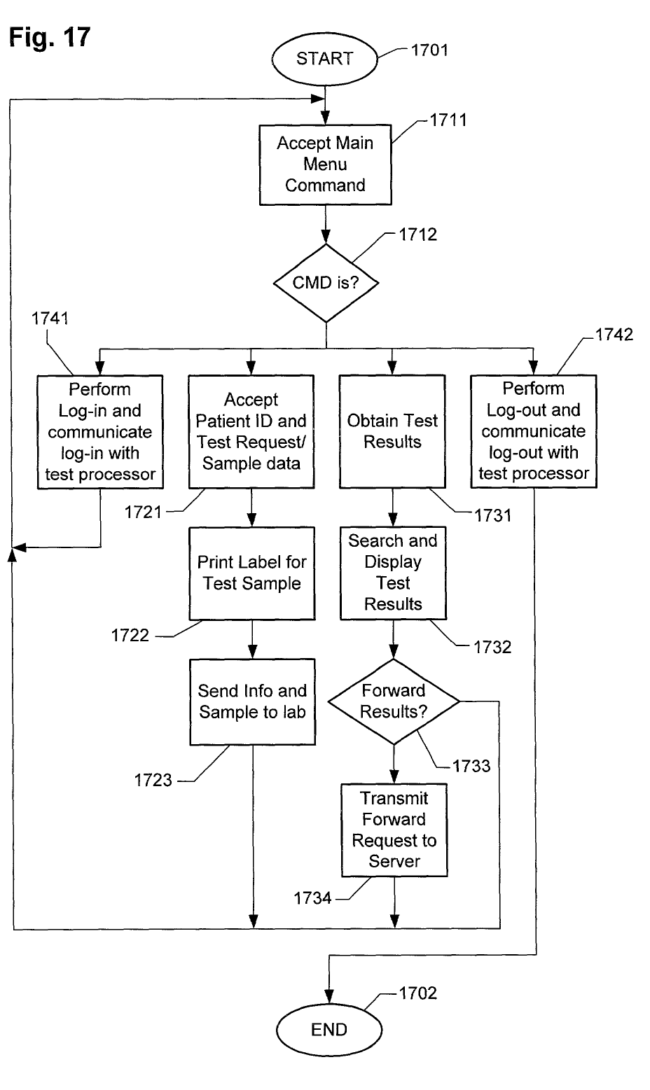

FIG. 17 illustrates operational flow for a hand-held health care provider computing system according to an embodiment of the present invention. The processing begins 1701 and a user is presented with a main command input menu by module 1711. The user operates the hand-held computer 101 by entering a command from the main command menu in module 1711. The command inputted by a user is checked in test module 1712 to determine which set of operational instructions are to be performed. When a set of operational instructions are performed in response to a user command input, the processing flows through the above instructions and the appropriate operational instructions to form a processing loop until all desired operations are performed.

If test module 1712 determines the main menu command input is a log-in command the processing continues to module 1741. The processing module 1741 performs a log-in operation for a user to the particular hand-held computer 101. The module 1741 will perform any user authentication processing necessary to determine that an identified user is accessing the hand-held computer 101. The module 1741 may communicate with the server based lab test message processor 112 to inform the overall system that a particular user is logged in and may be reached using this particular hand-held computer. Any other system administrative and initialization operations for the hand-held computer 101 may be performed at this time. Once all of this processing has completed, the processing returns to module 1711 to once again present the main menu to a user and await the next instruction.

If test module 1712 determines the main menu command input is a patient processing command the processing continues to module 1721. The processing module 1721 accepts input data from a user of the particular hand-held computer 101 associated with a patient and a test request, and corresponding test sample, being created and processed. Once all of the identification data has been entered, module 1722 prints one or more identification labels for use with the test sample collected from a patient that is sent to a lab testing facility 113 for analysis. The test sample is collected and the test sample is sent to the lab 113 and module 1723 communicates with the lab test message processor to provide all of the test request data for use when the test results are generated. Once all of this processing has completed, the processing returns to module 1711 to once again present the main menu to a user and await the next instruction.

If test module 1712 determines the main menu command input is a test results command the processing continues to module 1731. The processing in module 1731 obtains all pending test request messages addressed to the user of the hand-held computer 101 that are awaiting review at the lab test message computer 112. The user searches and displays the test results for one or more patients in module 1732. The user may forward some or all of these test results to additional parties. Test module 1733 determines if a user has indicated that test results are to be forwarded. If test module 1733 determines no messages are to be forwarded, the processing returns to module 1711 to once again present the main menu to a user and await the next instruction. If test module 1733 determines one or more messages are to be forwarded, these messages, along with an identification of the additional recipients, are sent to the lab test message processor in module 1734 for forwarding to these additional recipients. The module 1734 need only sent the lab test message processor 112 the identification of the test messages of interest and the identity of these recipients if these messages are still present within the data stores of the lab test message processor 112. If this data has been removed from these data stores, the entire set of data must be sent from the hand-held computer in order to permit the data forwarding operation to occur.

If test module 1712 determines the main menu command input is a log-out command the processing continues to module 1742. The processing in module 1742 performs a log-out operation for a user to the particular hand-held computer 101. The module 1742 performs system administrative and housekeeping operations needed to set the hand-held computer 101 back into a dormant state. The module 1741 may communicate with the server based lab test message processor 112 to inform the overall system that a particular user has logged out and may no longer be reached using this particular hand-held computer. Once all of this processing has completed, the processing ends 1702.

While the above embodiments of the present invention describe the interaction of a remote data input terminal such as a hand-held computer and a lab test message processor, one skilled in the are will recognize that the use of the hand-held PDA device may actually encompass a large number of variations on the type of data input terminal used. As long as the remote data input terminal is used by care-givers in the departments in which patients receive care and treatment, and as long as the lab test message processor is electronically connected to lab testing facility, the present invention to would be useable in the manner recited within the attached claims. It is to be understood that other embodiments may be utilized and operational changes may be made without departing from the scope of the present invention.

FIG. 2, 5 and 15 illustrates an example of a suitable operating environment 110 in which the invention may be implemented. The operating environment is only one example of a suitable operating environment 110 and is not intended to suggest any limitation as to the scope of use or functionality of the invention. Other well known computing systems, environments, and/or configurations that may be suitable for use with the invention include, but are not limited to, personal computers, server computers, held-held or laptop devices, multiprocessor systems, microprocessor-based systems, programmable consumer electronics, network PCs, minicomputers, mainframe computers, distributed computing environments that include any of the above systems or devices, and the like.

The invention may also be described in the general context of computer-executable instructions, such as program modules, executed by one or more computers or other devices. Generally, program modules include routines, programs, objects, components, data structures, etc. that perform particular tasks or implement particular abstract data types. Typically the functionality of the program modules may be combined or distributed in desired in various embodiments.

A network server 110 typically includes at least some form of computer readable media. Computer readable media can be any available media that can be accessed by the network server 110. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, BC-ROM, digital versatile disks (DVD) or other optical storage, magnetic cassettes, magnetic tape, magnetic disk storage or other magnetic storage devices, or any other medium which can be used to store the desired information and which can be accessed by the network server 110.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

While the above embodiments of the present invention describe a network based processing system providing processing services to remote clients, one skilled in the art will recognize that the various distributed computing architectures may be used to implement the present invention as recited within the attached claims. It is to be understood that other embodiments may be utilized and operational changes may be made without departing from the scope of the present invention.

As such, the foregoing description of the exemplary embodiments of the invention has been presented for the purposes of illustration and description. They are not intended to be exhaustive or to limit the invention to the precise forms disclosed. Many modifications and variations are possible in light of the above teaching. It is intended that the scope of the invention be limited not with this detailed description, but rather by the claims appended hereto. Thus the present invention is presently embodied as a method, apparatus, computer storage medium or propagated signal containing a computer program for providing wireless communication of test orders from a health care provider to a medical testing system that automatically transmits the test results, when completed to one or more designated health care providers.

What is claimed is:

1. A method for requesting and receiving medical patient test results using a remote data input terminal in communication with a server-based lab test message computer, the method comprising:
receiving a test sample collected to perform the requested medical patient test with the patient identification information and the test identification information;
receiving the patient identification information and the test identification information from the remote data input terminal in order to request the medical patient tests to be performed upon the collected test sample;
transmitting a test result message containing test results for the requested medical patient test to the remote data input terminal; and
displaying the test results from the requested medical patient test on the remote data input terminal.

2. The method according to claim 1, wherein the remote data input terminal comprises a hand-held computer having a wireless communications interface for communicating with the lab test message processor.

3. The method according to claim 2, wherein the remote data input terminal further comprises a bar code scanner for receiving data input.

4. The method according to claim 3, wherein the remote data input terminal further comprises a pen-based user input screen for accepting input from a user.

5. The method according to claim 1, wherein the entering patient identification information comprises scanning a patient bar code containing a unique patient ID.

6. The method according to claim 5, wherein the patient bar code is located on a patient bracelet worn by the patient.

7. The method according to claim 5, wherein the patient bar code is located on a patient chart.

8. The method according to claim 1, wherein the patient identification information and the test identification information comprises one or more bar codes.

9. The method according to claim 1, wherein the method further comprises:
entering patient identification information for a medical patient test requested to be performed into the remote data input terminal;
entering test identification information for identifying the medical patient test requested be performed into the remote data input terminal;
identifying one or more recipients for the test result message; and
transmitting the one or more recipient's identity to the lab test message processor for use when sending the test results to desired recipients.

10. The method according to claim 9, wherein the method further comprises:
receiving the identity of one or more additional recipients for the test result message; and
forwarding the test result message to the one or more additional recipients.

11. The method according to claim 10, wherein the forwarding the test result message comprises:
receiving the identity of the one or more additional recipients to the lab test message processor; and
sending the test result message to the additional recipients.

12. A computer-readable medium having computer-executable instructions for the method recited in claim 1.

13. A computer-readable medium having computer-executable instructions for the method recited in claim 11.

14. A server-based lab test message processor in digital communications with a remote data input terminal having a user interface screen for a receiving medical patient requests and transmitting test results, the server-based lab test message processor comprising:
a control processing module for controlling the operation of the server;
a test request message receive module for receiving medical test request messages from the remote data input terminal, the medical test request messages contain test identification information for identifying the medical patient test and patient identification information for identifying the patient;
a test result message transmit module for sending medical test result messages to the remote data input terminal, the test result messages contain test identification information for identifying the medical patient test performed and patient identification information for identifying the patient;
a test result message receive module for receiving medical test result messages from a lab testing facility; and
an internal database for maintaining test request messages and test result messages;
wherein the control processing module matches test request with test result messages and the test request messages using the test identification information and the patient identification information.

15. The lab test message processor according to claim 14, wherein the lab test message computer comprises a wireless communications module for communicating with the remote data input terminal.

16. The lab test message processor according to claim 15, wherein the remote data input terminal is a hand-held computer that accepts pen-based input data generated using pen strokes from a stylus upon a user interface screen

17. The lab test message processor according to claim 15, wherein the remote data input terminal further comprises a user ID scanning module for accepting input for the patient identification information and the test identification information.

18. The lab test message processor according to claim 17, wherein the user ID scanning module comprises a scanning module for scanning bar codes.

19. The lab test message processor according to claim 18, wherein the lab test message processor further comprises a patient records interface module for transmitting test result records to a patient records processing system.
